(19) United States
(12) Patent Application Publication
(10) Pub. No.: US 2002/0116360 A1
(43) Pub. Date: Aug. 22, 2002

(54) Service method for distribution of music files with protected copyright over internet

(76) Inventors: Jeong-Taek Oh, Youngju (KR); Kenneth Hong, Seoul (KR)

Correspondence Address: JACOBSON, PRICE, HOLMAN & STERN, PROFESSIONAL LIMITED LIABILITY COMPANY, 400 SEVENTH STREET N.W., WASHINGTON, DC, 20004, US

(21) Appl. No.: 09/833,710

(22) Filed: Apr. 13, 2001

(30) Foreign Application Priority Data
Feb. 19, 2001 (KR) 2001-8167

(51) Int. Cl. G06F 7/00

(52) U.S. Cl. 707/1

(57) ABSTRACT

A service method for distribution of music files with protected copyright over the Internet, comprising the step of downloading a music listening program from a music file database server, the step of entering desired user information and registering and approving a user as a member, the step of searching for and selecting a specific music file from the music file database server and requesting its transmission, the step of appending a target image advertisement associated with the registered information of the user and music associated overhead information to the selected specific music file and storing the resulting specific music file in the music file database server, the step of transmitting the specific music file to a user computer over an Internet network and automatically displaying the target image advertisement of the specific music file, the step of automatically accumulating the number of times that the target image advertisement of the specific music file is provided and then transferring the accumulated number to an advertiser of the target image advertisement, and the step of if the user clicks on the overhead information or target image advertisement contained in the specific music file, displaying the associated contents or moving to a Web site linked thereto.

### BACKGROUND OF THE INVENTION

1. Field of the Invention

The present invention relates in general to a method for providing a music file distribution service over the Internet, which is capable of distributing music files free of charge under the condition that the music files are protected in copyright and gaining advertising revenue from the distributed music files, and more particularly to a service method for distribution of music files with protected copyright over the Internet, which is capable of appending overhead information and an image advertisement or commodity information associated with a specific user to a music file selected by the specific user, officially distributing the resulting music file to the specific user free of charge over the Internet and obtaining advertising revenue from the distributed music file by linking the image advertisement and overhead information in the distributed music file to a variety of communities and electronic commerce sites.

2. Description of the Prior Art

Recently, with the rapid growth of the Internet, users thereof have explosively increased in number. The Internet enables the exchange of bulky information and provides a variety of information closely related to daily life.

In particular, in the twenty-first century, many enterprises expend great efforts to increase their sales over information networks, including the Internet, and develop multifaceted marketing strategies to rapidly cope with changing service requirements from customers. Furthermore, since personal computers (PCs) have widely spread nationally and internationally, information uses/exchange/growth increase rapidly, causing individuals as well as enterprises to adapt their daily routines to the Internet age.

In the Internet age, high-speed Internet communication networks must first be constructed with improvements in computer system performance. High-speed communication networks, such as an integrated services digital network (ISDN), asymmetric digital subscriber line (ADSL) and the like, have been developed to significantly increase the rate of access to external communication networks and thus accelerate the generalization of Internet use. Moreover, most personal computers can sufficiently perform a multimedia function, thereby enabling users or Web clients to three-dimensionally receive a variety of information from the Internet according to their individual capabilities.

On the other hand, the rapid development of the Internet has accelerated the digitization of media besides information search; resulting in a change from either tapes of an analog type or compact disks (CDs) of a wave type to moving picture experts group (MPEG) audio media with excellent compression and transmission rates. Particularly, among the MPEG audio media, the most advanced MP3 medium can not only store general audio data but also transmit high-quality music at a high speed using various communication means. In this regard, the MP3 medium has explosively increasingly been used.

This MP3 (MPEG Audio Layer-3) technique is an audio compression standard with excellent sound quality and capacity compressible up to 1/11 of that of an existing wave file. As a result, it is the current reality that information-providing Web sites as well as music dedicated Web sites actively provide an MP3-based music file distribution service for the purpose of increasing the number of accesses by users.

Further, MP3 sharing programs, such as Napster, Soribada, etc., currently causes a serious problem, that is, the infringement of copyright in the compact disc market. These programs are an obstacle to music file providers' right to gain profits from music files, and cannot also provide music files of good quality to users due to the sharing of MP3 files among the users.

Further, music file providers, who provide MP3-based music files on the Internet, cannot provide music files without permission in consideration of copyright laws protecting the music files. Furthermore, it is actually difficult for the music file providers to provide a music file service, not related directly to information provision, while bearing the copyright cost.

### DISCLOSURE OF THE INVENTION

Therefore, the present invention has been made in view of the above problems, and it is an object of the present invention to provide a service method for distribution of music files with protected copyright over the Internet, which is capable of appending overhead information and an image advertisement associated with a specific user to a music file selected by the specific user, officially distributing the resulting music file to the specific user free of charge over the Internet and obtaining advertising revenue from the distributed music file by linking the image advertisement and overhead information in the distributed music file to a variety of communities and electronic commerce sites, while collecting a fee for using the music file in order not to infringe the copyright of the music file.

In accordance with the present invention, the above and other objects can be accomplished by the provision of a service method for distribution of music files with protected copyright over the Internet, comprising the steps of a) downloading a music listening program from a music file database server and running it in a computer of a user to download a music file with music, an image advertisement and overhead information from the music file database server and execute the downloaded music file in the user computer; b) entering user information desired by the music file database server and registering and approving the user as a member capable of downloading a desired specific music file from the music file database server; c) searching for and selecting the specific music file from the music file database server and requesting its transmission; d) appending a target image advertisement associated with the registered information of the user and music associated overhead information to the selected specific music file and storing the resulting specific music file in the music file database server; e) transmitting the specific music file stored in the music file database server to the user computer over an Internet network and automatically displaying the target image advertisement of the specific music file for a downloading period of time and a listening period of time; f) automatically accumulating the number of times that the target image advertisement of the specific music file is provided, in the music file database server and then transferring the accumulated number to an advertiser of the target image advertisement; g) if the user clicks on the overhead information or target image advertisement contained in the specific music file, displaying the associated contents or moving to a Web site linked thereto; and h) surfing on music associated community contents or searching for information of a commodity of the target image advertisement and purchasing the commodity through electronic commerce.

Preferably, the music file database server may collect a fee for using the specific music file with the help of the advertiser and include a music file database for storing the specific music file; an advertisement database for storing the target image advertisement; and an overhead information database for storing the overhead information; whereby the specific music file with the target image advertisement associated with the registered information of the user and the music associated overhead information is automatically transmitted to the user.

Further, preferably, the above step f) may include the step of automatically accumulating the number of times that the target image advertisement of the specific music file is provided, in the music file database server and then transferring the accumulated number to the advertiser of the target image advertisement to be utilized as target advertisement setting data by the advertiser; and the above step d) may include the step of formatting the specific music file in an MPEG Audio Layer-3 or advanced audio coding manner and storing it in a tag form.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a service method for distribution of music files with protected copyright over the Internet in accordance with the present invention;

FIG. 2 is a block diagram showing the construction of a system for execution of the service method of the present invention; and

FIG. 3 is a block diagram showing a reproduction flow of music files transmitted by the service method of the present invention.

### DETAILED DESCRIPTION OF THE PREFERRED EMBODIMENTS

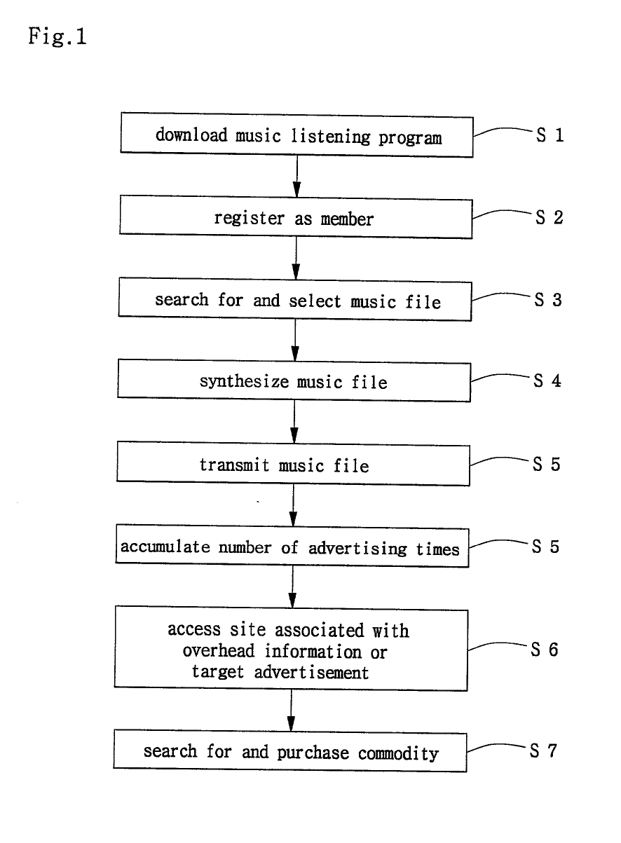

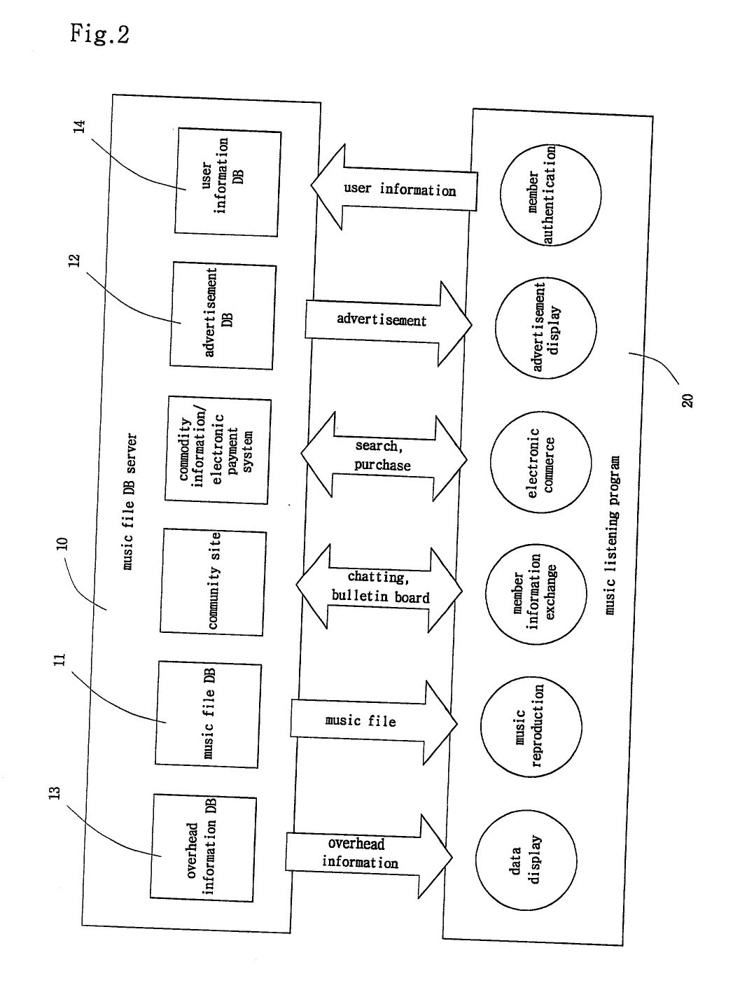

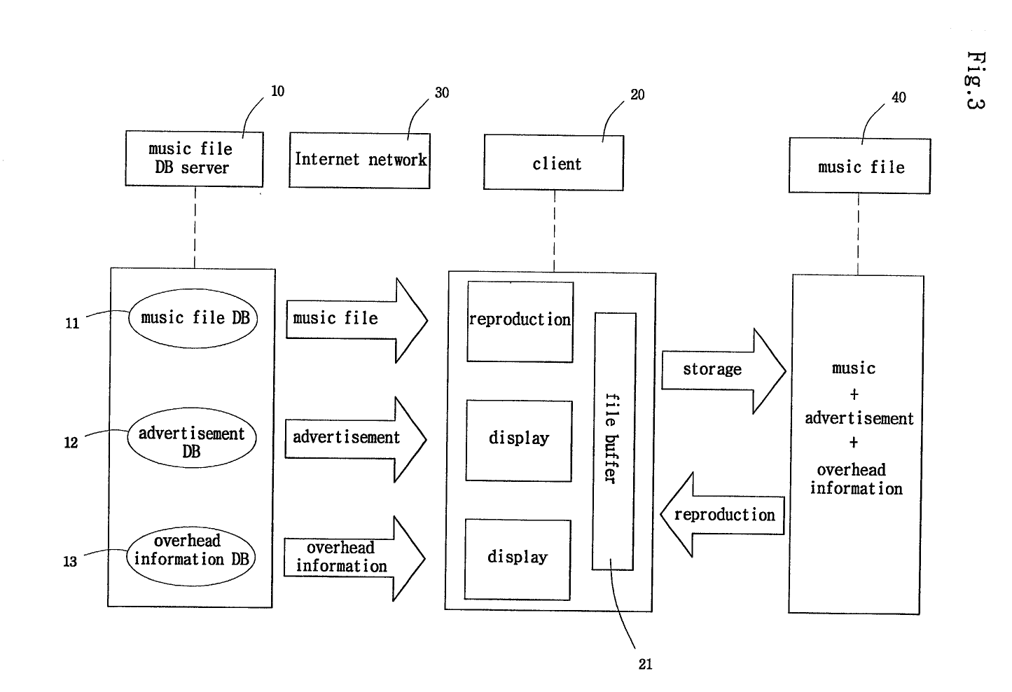

FIG. 1 is a flowchart illustrating a service method for distribution of music files with protected copyright over the Internet in accordance with the present invention, FIG. 2 is a block diagram showing the construction of a system for execution of the present service method, and FIG. 3 is a block diagram showing a reproduction flow of music files transmitted by the present service method. As shown in these drawings, a service provider can officially distribute a music file 40 with a target advertisement, provided in the form of an image, and overhead information to a specific user free of charge over an Internet network 30. The service provider can collect a fee for using the music file 40 with the help of an advertiser of the target advertisement in order not to infringe the copyright of the music file. Further, the specific user can automatically gain access to a variety of communities and electronic commerce sites via the image advertisement and overhead information in the music file 40, thereby enabling the service provider to gain advertising revenue from the music file 40.

This system is adapted to format the music file 40 according to an MP3-based advanced audio coding (AAC) technique. The AAC technique is currently recognized to be a next-generation digital audio technique with more excellent compression rate and reproduced sound quality than the MP3 technique. The service provider can officially distribute the music file 40 with an image advertisement and overhead information to a specific user, registered as a member, free of charge over the Internet network 30. Upon downloading the music file 40 with the image advertisement and overhead information, the specific user can appreciate music contained in the downloaded music file 40 using a client, or a music listening program 20, without bearing the copyright cost.

The overhead information contains the contents associated with music, and the image advertisement is selected according to information of the specific user, appended to the music file and then displayed. If the specific user clicks on the overhead information or image advertisement in the downloaded music file, then the music listening program 20 is automatically moved to a Web site of an advertiser of the image advertisement and may in turn be connected to a plurality of electronic commerce sites and community Web sites. The client, or the music listening program 20, preferably includes a sound digital package (SDP), a file formatter and a player to extract the music associated overhead information from the downloaded music file, automatically display the image advertisement contained in the downloaded music file and reproduce or store the downloaded music file.

The music listening program 20 preferably includes a function of registering a user as a member to select and download a desired music file, a function of enabling the user to listen to music of the downloaded music file, and a function of storing one music file 40 into which are synthesized music selected by the user, overhead information expressing the contents of the selected music as images and a commodity advertisement associated with information of the user.

Further, the music listening program 20 includes a function of automatically displaying the commodity advertisement associated with the user information on a computer of the user for a period of time that the user downloads the music file 40 or listens to the music of the music file 40, a function of extracting and displaying the overhead information from the music file 40, related to the music of the music file 40, a function of accessing a community Web site associated with the music of the music file 40 and using a bulletin board on the accessed Web site or chatting with other users thereon, and an electronic commerce function of searching for information regarding a commodity of the target advertisement in the music file 40 and purchasing the commodity, thereby enabling the service provider, or server operator, to receive advertising revenue from an advertiser of the target advertisement in the music file 40 and the advertiser to gain profits as a result of the commodity purchasing.

A music file database (DB) server 10 is adapted to provide the music file 40 to the user registered as a member through the music listening program 20. The music file DB server 10 preferably includes a function of authenticating a member requesting a log-in process, a function of allowing the member to search for and select a desired music file and transmitting the selected music file, a function of selecting and transmitting overhead information related to music of the selected music file, and a function of selecting and transmitting an effective target advertisement associated with a field in which the listener, or the user, is highly interested, on the basis of member information.

Further, the music file DB server 10 includes a function of, when the user selects the desired music file and requests its transmission, synthesizing the target advertisement and overhead information with the music of the selected music file and transmitting the resulting music file, a function acting as a community Web site server, and a function acting as an electronic commerce site for gaining profits.

In the above manner, the music file distribution service method is able to distribute copyrighted music files to users free of charge on the basis of the music file DB server 10, music listening program 20 and Internet network 30 while gaining profits from the distributed music files. To this end, first, the user downloads the music listening program 20 from the music file DB server 10 and runs it in his or her computer to download and execute a music file 40 with music, an image advertisement and overhead information in the computer (S1).

Then, in order to download a music file 40 from an associated Web site without bearing the copyright cost, the user enters user information desired by the music file DB server 10 to register himself or herself as a member and is then approved as a member (S2). The user information contains personal tastes and consumption patterns, as well as basic personal information. Further, the user information is stored in the music file DB server 10 to be used for transmission of a commodity advertisement suitable to the user together with a music file 40.

After the member registration and approval, the user searches for and selects a desired music file from the Web site and requests its transmission (S3). Then, the music file DB server 10 appends a target image advertisement associated with the registered information of the user and music associated overhead information to the selected music file and stores the resulting music file 40 (S4).

Prior to transmission of the music file 40 to the user over the Internet network 30, the service provider, or the server operator, makes a contract for payment of an advertising rate with an advertiser of the target image advertisement to collect a fee for using the music file 40 with the help of the advertiser, thereby distributing the music file 40 to the user free of charge without infringing the copyright of the music file 40. The music file DB server 10 preferably includes a music file DB 11 for storing the music file, an advertisement DB 12 for storing the target image advertisement, and an overhead information DB 13 for storing the overhead information. The music file is preferably formatted in an MP3 or AAC manner such that it can be stored in a tag form and then linked to an associated community Web site or provided as a self-advertisement file.

The music file DB server 10 synthesizes the music file from the music file DB 11 with the image advertisement from the advertisement DB 12 and the overhead information from the overhead information DB 13 and then transmits the resulting music file 40 (S5). Provided that the user wishes to listen to music of the music file 40 in real time, the client reproduces it simultaneously with its transmission. But, in the case where the user merely desires to download the music file 40, the client stores it in a buffer 21.

At this time, the client, or the music listening program 20, automatically displays the commodity advertisement from the music file DB server 10, and stores the overhead information from the music file DB server 10 in the buffer 21 such that the stored overhead information is selectively displayed in response to a display request from the user. Alternatively, the music, commodity advertisement and overhead information of the music file 40 may be sequentially transmitted and automatically stored.

The music, commodity advertisement and overhead information of the music file 40 are preferably stored in a tag form such that data related to a commodity of the community Web site or advertisement is provided for the commodity search or purchasing by the user. The overhead information may preferably include a variety of contents (for example, a composer, lyrics, genre and session) associated with the music of the music file, photograph data of the music, image data of the music, etc.

The client reproduces the music file from the music file DB server 10 in response to a play request from the user. For reproduction, the client reads the music file 40 from the buffer 21, extracts the music, target advertisement and overhead information therefrom separately from one another and reproduces the extracted music. Then, the client displays the target advertisement associated with the user or the overhead information while reproducing the music. The overhead information may preferably be always displayed even when the music is not reproduced.

In other words, the music file DB server 10 transmits the music file 40 to the computer of the user over the Internet network 30 at the above music file transmission step S5. At this time, the target image advertisement contained in the music file 40 is automatically displayed on the user computer while the user listens to the music contained in the music file 40 as well as while the file 40 is downloaded to the user computer, thereby causing the user to view the displayed advertisement with a deep interest and no particular resistance. Further, the user may gain access to a Web site linked to the displayed commodity advertisement and then conduct electronic transactions on the accessed Web site.

On the other hand, whenever the music file 40 is downloaded to a user computer, the music file DB server 10 automatically accumulates the number of times that the target advertisement of the music file 40 is provided and then transfers the accumulated number to the advertiser (S6). Namely, the number of times that the target advertisement of the music file 40 is provided and the number of times that users visit a Web site linked to the target advertisement are automatically calculated and then provided to the advertiser, thereby enabling the advertiser to identify a more reliable commodity purchasing class and utilize the identified class as marketing data.

In other words, if a user logs in through the client, or the music listening program 20, and selects a desired music file, then the music file DB server 10 selects a commodity advertisement most appropriate to the selected music file on the basis of member information (for example, age, sex, place of residence, taste, etc.) entered for member registration, an advertisement previously transmitted together with the selected music file, data previously searched by the user or information of commodities previously purchased by the user, and automatically processes and transmits the selected commodity advertisement so as to maximize the advertising effect.

If the user clicks on the overhead information or target advertisement contained in the music file 40, then the client displays the associated contents or moves to a Web site linked thereto (S7) so that the user can surf on the music associated community contents or search for information of a commodity of the target advertisement and purchase the commodity (S8).

In the music file distribution service method of the present invention, the music file is preferably linked to a variety of community Web sites for the creation of a community about the music selected by the user. For example, the client may be automatically connected to a music fan club or public relations site designated by the overhead information in the music file while the user selects the music file or listens to the music of the file.

The linked Web sites are constructed in a general manner such that the user shares opinions on the music with other users or chats with them. On a certain portion of the screen are displayed tags linked to the image advertisement in the music file and advertisement associated commodity search and purchase sites such that the client is automatically connected to the advertisement and sites when the user pushes the tags, leading to the maximization of advertising effect.

Preferably, the music file 40, distributed free of charge according to the present invention, may be employed as a medium for Internet radio broadcasting of good quality in that it can be transmitted and reproduced in real time. In this case, a specific Internet broadcasting station can couple a selected advertisement with specific music and transmit the resulting music file, thereby gaining profits while solving the copyright problem, as stated above.

As apparent from the above description, the present invention provides a service method for distribution of music files with protected copyright over the Internet. This service method is capable of appending overhead information and an image advertisement associated with a specific user to a music file selected by the specific user, officially distributing the resulting music file to the specific user free of charge over the Internet and obtaining advertising revenue from the distributed music file by linking the image advertisement and overhead information in the distributed music file to a variety of communities and electronic commerce sites, while collecting a fee for using the music file in order not to infringe the copyright of the music file. Therefore, the user can appreciate music of the music file free of charge, a service provider, or a server operator, can receive advertising revenue from an advertiser of the image advertisement in the music file, and the advertiser can gain profits from electronic transactions of a commodity of the image advertisement.

Further, according to this invention, the music file can be distributed hierarchically and locally on the basis of its image expressible format and a music listening program. Therefore, the present invention will be able to occupy a portal site for a digital music service to lead the next-generation musical industry under future new superhighway wired/wireless communication environments.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A service method for distribution of music files with protected copyright over the Internet, comprising the steps of:
a) downloading a music listening program from a music file database server and running it in a computer of a user to download a music file with music, an image advertisement and overhead information from said music file database server and execute the downloaded music file in the user computer;
b) entering user information desired by said music file database server and registering and approving the user as a member capable of downloading a desired specific music file from said music file database server;
c) searching for and selecting said specific music file from said music file database server and requesting its transmission;
d) appending a target image advertisement associated with the registered information of said user and music associated overhead information to the selected specific music file and storing the resulting specific music file in said music file database server;
e) transmitting said specific music file stored in said music file database server to said user computer over an Internet network and automatically displaying said target image advertisement of said specific music file for a downloading period of time and a listening period of time;
f) automatically accumulating the number of times that said target image advertisement of said specific music file is provided, in said music file database server and then transferring the accumulated number to an advertiser of said target image advertisement;
g) if said user clicks on said overhead information or target image advertisement contained in said specific music file, displaying the associated contents or moving to a Web site linked thereto; and
h) surfing on music associated community contents or searching for information of a commodity of said target image advertisement and purchasing the commodity through electronic commerce.

2. A service method for distribution of music files with protected copyright over the Internet, as set forth in claim 1, wherein said music file database server is adapted to collect a fee for using said specific music file with the help of said advertiser and includes:
a music file database for storing said specific music file;
an advertisement database for storing said target image advertisement; and
an overhead information database for storing said overhead information;
whereby said specific music file with said target image advertisement associated with the registered information of said user and the music associated overhead information is automatically transmitted to said user.

3. A service method for distribution of music files with protected copyright over the Internet, as set forth in claim 1, wherein said step f) includes the step of automatically accumulating the number of times that said target image advertisement of said specific music file is provided, in said music file database server and then transferring the accumulated number to said advertiser of said target image advertisement to be utilized as target advertisement setting data by said advertiser; and
wherein said step d) includes the step of formatting said specific music file in an MPEG Audio Layer-3or advanced audio coding manner and storing it in a tag form.
